(19) United States
(12) Patent Application Publication
(10) Pub. No.: US 2008/0281650 A1
(43) Pub. Date: Nov. 13, 2008

(54) METHOD FOR COMPUTING THE RESILIENCY SCORE OF AN ORGANIZATION OR ANY PART THEREOF

(76) Inventors: Rohit M Lotlikar, Bangalore (IN); Anuradha Bhamidipaty, Bangalore (IN); Guruduth S. Banavar, Pelham Manor, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/745,501

(22) Filed: May 8, 2007

(51) Int. Cl. G06Q 10/00

(52) U.S. Cl. 705/7

(57) ABSTRACT

A method computes a resiliency score of an entity by representing the entity as a set of components. The method determines interactions and relationships and can, in one embodiment, determine two types of relationships between the components to produce resiliency scores for the components. These two types of relationships comprise a dependency relationship (whether a first component depends on one or more additional components to function) and a substitution relationship (whether two or more components share some functionality, and whether the first component can be at least partially substituted for one or more additional components). The method computes and outputs an overall score representing a resiliency of the entity based on the scores of the components of the entity and relationships between the components.

### BACKGROUND AND SUMMARY

The embodiments of the invention generally relate to computing the resiliency score of an organization.

With the increasing trend in outsourcing and globalization of IT services, there is an increasing sensitivity on the part of both the service provider organizations and their customers to the vulnerabilities that may affect the provider's ability to seamlessly deliver services. Organizations need a way to access the resilience of their operations (and their vendors) to analyze the impact that failures—both internal and external, small scale and large scale can have on the output of their operations. This helps guide investment decisions concerning business resilience. When businesses outsource certain services to vendors, they need an objective way to evaluate, compare and differentiate vendors on resiliency considerations. These evaluations form valuable inputs into the pricing and sourcing decisions.

This invention describes a novel method and apparatus for quantitatively determining the resiliency of an organization. It represents an organization by a set of components which can be independently assessed for resiliency. The complex interactions/relationships between components are captured in the model at different levels of abstraction and an overall score representing the resiliency for whole or part of an organization is computed by combining the scores of the components.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram illustrating an embodiment of the invention; and

FIG. 2 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

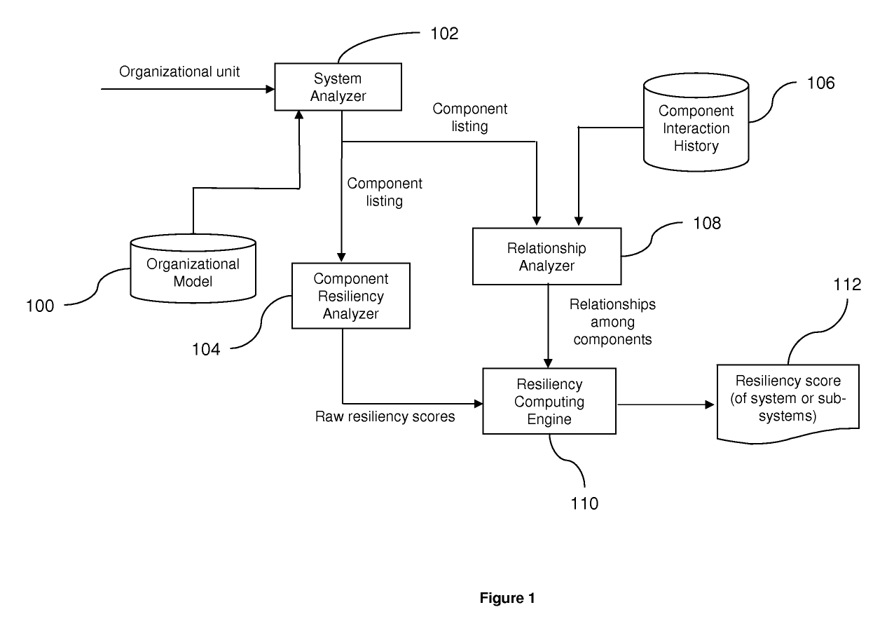

This invention provides a method and apparatus for quantitatively determining the resiliency score of an organization (entity) as a whole of any part thereof, as shown in FIG. 1. The method identifies the individual components of an organization which can be independently accessed for resiliency and each of the components is analyzed and assigned a resiliency score. The relationships which represent the interactions between the components are determined and used to compute an overall resiliency score for the organization as a whole or part.

An organization unit (whole or part) can be accessed for its resiliency. The system analyzer 102 component determines sets of components of the organizational unit which can be independently accessed for resiliency using an organizational model 100, if any.

The component listing thus derived is sent to the component resiliency analyzer 104 and relationship analyzer 108 components. The component resiliency analyzer 104 component analyzes the components independently and assigns a quantitative score to each component which represents the resiliency of that component. The scores are the raw resiliency scores.

The relationship analyzer 108 component captures the relationships between components which represent how they interact with each other to perform the business functions. These relationships can be determined with the help of a component interaction history 106 database.

The raw resiliency scores of the components and their relationships are fed into the resiliency computing engine 110 which computes an overall score 112 representing the resiliency of the organizational unit.

Existing methods for resiliency (also known as reliability and availability) analysis are domain dependent - designed for specific classes of engineering systems [1], [3], IT systems, or software [2]. Note that references to articles and publications herein appear below, before the claims. Typically such methods are all based on assignment of probabilities of failure (or similar measures such as mean time to failure, failure rates etc.) of failure to individual components, and use domain specific models to characterize the interactions between components. However, this methodology cannot be applied for characterizing the resiliency of organizations for two reasons.

One reason is that such methods require that components be characterized in precise terms such as failure probabilities or mean time to failure which is impractical to determine for components of an organization. To the contrary, the inventive methodology is flexible regarding the way the components are characterized. In one embodiment, criteria to assign scores to components are based on the design of the component and are in the form of natural languages descriptions.

The interaction between organizational components—particularly between non-technology aspects such as people and processes is flexible. The flexible nature of interaction cannot be taken into account by methods designed for Engineering, IT or software systems. The substitution relationship feature of the invention enables this flexibility to be factored in.

The invention provides a detailed description of each of the components in FIG. 1. This disclosure also illustrates the working of a solution with an example. In one embodiment of the invention, the system comprises a (a) System analyzer 102, (b) Component Resiliency analyzer 104, (c) Relationship analyzer 108 and (d) Resiliency Computing Engine 110.

A user can analyze the resiliency of any organizational unit either in whole or a part. The system analyzer 102 component determines the set of components in the organizational unit which can be independently accessed for resiliency. The system analyzer 102 can optionally use an organizational model 100 to determine these sets of components.

For example, a call-center can have an organizational model 100 to describe the set of standard components like network infrastructure, voice infrastructure, computing environment, and call-center personnel etc. The user can additionally manually identify other components which can be accessed for resiliency.

The set of components thus identified (called the component listing) is sent to component resiliency analyzer 104 to compute the resiliency score for each component. The resiliency score for each component can be computed in multiple ways. In one way, each component can have descriptions of pre-defined resiliency maturity levels and one of the maturity levels is assigned to it. Another way is to compute the failure of probabilities for each component to represent the resiliency score. Yet another way is to have a specialist rate the component. These scores are termed as raw resiliency scores.

The set of components identified is also sent to the relationship analyzer 108 component which identifies the relationships/interactions between the components. The relationship analyzer 108 can optionally use a database of component interaction history 106 to identify the relationships.

The component interaction history 106 can be constructed from the responses to a crisis or disruption scenario. For example, if during a crisis, an office building becomes unavailable and operations (either whole or some %) can be resumed from another off-site building, then there is a relationship between the two office buildings. Similarly, if an office building becoming unavailable also disrupts the network availability too, then there is a relationship between the office building and the network.

The relationship analyzer 108 using the component interaction history 106 identifies two kinds of relationships. One type of relationship is a dependency relationship wherein a component depends on one or more components to function. Another type of relationship is a substitution relationship wherein two or more components share some functionality, that is, one component can be substituted to some degree for the other component. A degree of substitution defines the degree of functionality that is shared.

For example, the relationship analyzer 108 can identify relationships like a data network being dependent on the office building being available, so there exists a dependency relationship from data network to office building. An office building can be substituted with an off-site building with a degree of substitution, say 0.8, which means that 80% of the operations can be resumed from the off-site building if there is any disruption to the main building. The raw resiliency scores computed for each of the components and the relationships between these components identified are sent to the resiliency computing engine 110 which computes an overall resiliency score 112 for the organizational unit. The resiliency computing engine 110 combines the scores of the components using the relationships in an iterative fashion.

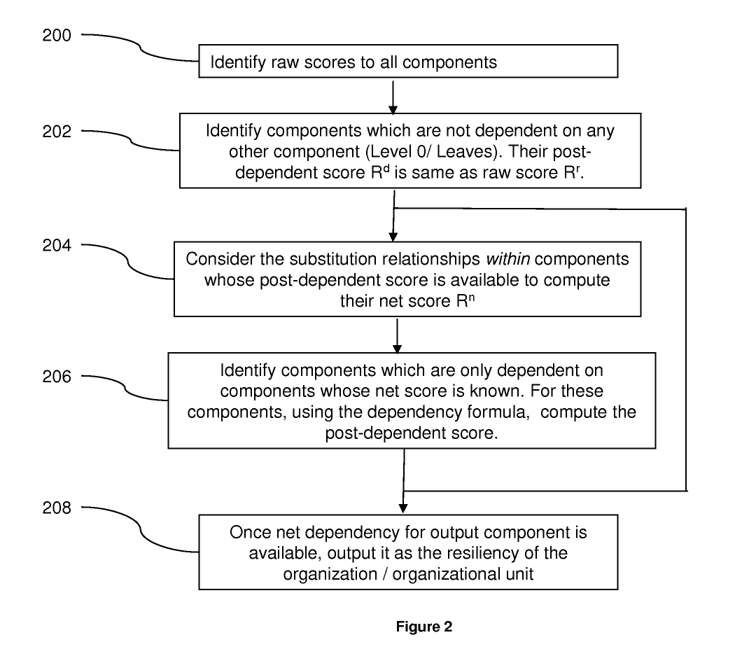

The invention, in terms of a flow-chart is described in FIG. 2. More specifically, in item 200, one embodiment identifies raw scores of all components. In item 202, the method identifies components which are not dependent on any other component (called Level 0 or Leaves). Their post-dependent score R^{d} is the same as the raw score R^{r}. Further, item 204 can optionally consider the substitution relationships within components whose post-dependent score is available to compute their net score Rⁿ. In item 206, the method identifies components which are only dependent on components whose net score is known. For these components, using the dependency formula, the method computes the post-dependent score. Thus, in item 208, once the net dependency for output component is available, the method outputs this as the resiliency of the organization or organizational unit.

Thus, in one example, the invention comprises a method of computing a resiliency score of an entity that begins by representing the entity as a set of components. The method determines interactions and relationships and can, in one embodiment, determine two types of relationships between the components to produce resiliency scores for the components. Again, these two types of relationships comprise a dependency relationship (whether a first component depends on one or more additional components to function) and a substitution relationship (whether two or more components share some functionality, and whether the first component can be at least partially substituted for one or more additional components). The method computes and outputs an overall score representing a resiliency of the entity based on the scores of the components of the entity and the relationships between them. Embodiments herein independently assess the relationships of the components to determine a resiliency score for each of the components independently. Further, the relationships between the components can be captured using a model having different levels of abstraction.

The following paragraphs describe some exemplary formulae which can be used for computing the post-dependent scores and net scores. In these examples, the resiliency scores for the components are assigned a value between 1 and Rmax.

A post-dependent score is the score obtained by combining the score of that object with that of the objects that it is dependent on. If an object is not dependent on other objects, its post-dependent score is the same as its raw score. The invention can use the following function to compute a post-dependent score:

DepFunction(A, List(A₁, A₂ . . . Aₙ))=(A*A₁*A₂ . . . *Aₙ)̂(1/(n+1))

where component A is dependent on components A₁, A₂. . . Aₙ.

A net score is the score obtained by combining the score of that object with that of the objects that it can be substituted with. If an object is not in a substitution relationship with any object, its net score is its post-dependent score. The invention can use the following function to compute a net score:

SubFunction(A, A₁, θ₁, A₂, θ₂)=A+(1/Rmax*A₁*θ₁*(Rₘₐₓ−A))+(0.2* A₂*θ₂*(Rₘₐₓ−A))

where component A can be substituted by components A1 for a fraction θ1 of its operations and can be substituted by A2 for a fraction θ2 of its operations. Rmax is the maximum possible raw score that a component can have.

The net score for the output component is the overall score for the organizational unit. The resiliency score thus computed is output to the user (208). The user can drill-down the score to view the scores for each component, or sub-system within the organizational unit.

In another embodiment of the invention, a user can manually identify the relationships between the components for the system. In another embodiment of the invention, a user can manually define and identify new types of relationships (other than dependency and substitution) to capture the interactions between components. In yet another embodiment of the invention, different formulae for combining the scores of the components can be used to compute the overall resiliency score for the organizational unit. In a further embodiment of the invention, a component can be refined or defined further by sub-components and resiliency scores are assigned to each such sub-component. The component score can be computed from the scores of its sub-components.

The invention is illustrated using an example of an IT service provider organization and the subsystem in the organization which provides the event management service to an organizational unit for which the invention needs to analyze the resiliency. The system analyzer 102 component determines the following set of components that constitute this organizational unit:

1. Main office building

2. Home office

3. Voice network

4. Data network

5. Email application

6. Problem management application

7. Event management process

8. Personnel

The component resiliency analyzer 104 analyzes each of these components and assigns a resiliency score between 1 and 5 based on pre-defined descriptions of what each level means for each component. The raw resiliency scores for each of these components are given in the table below:

| Component | Score |
|---|---|
| Main office facility | 3.67 |
| Home office facility | 3.0 |
| Voice network | 5.0 |
| Data network | 5.0 |
| Email application | 2.0 |
| Problem | 2.25 |
| management | |
| application | |
| Event management | 5.0 |
| process | |
| Personnel | 2.67 |

The relationship analyzer 108 component identifies the following relationships between these components:

Dependency relationships:

| Component | Dependent component |
|---|---|
| Data network | Main office facility |
| Voice network | Main office facility |
| Email application | Data network |
| Problem management application | Data network |
| Event management process | Problem management application |
| Event management process | Personnel |

Substitution relationships:

| Component | Substitutable component | Degree of substitution |
|---|---|---|
| Home office | Main office facility | 80% |
| Email application | Voice network (phone calls) | 30% |

The resiliency computing engine 110 uses the algorithm described in FIG. 2 to compute the overall resiliency score for the organizational unit to be 3.46

The invention provides a systematic approach to quantitatively determine resiliency of an organization. The invention represents the organization by a set of components which can be independently assessed for resiliency. The computation of the resiliency score of the organization is independent of the method used to assess individual components. The embodiments herein capture complex relationships/interactions between components in the organization at various levels of abstraction. Further, the embodiments herein compute the resiliency score for whole or any part of the organization.

As mentioned above, outsourcing and globalization of IT services has resulted in increasing sensitivity on the part of both the provider organizations and their customers to the vulnerabilities that may affect the provider's ability to seamlessly deliver services. The present invention can be used for internal resiliency assessment or by a consulting firm for resiliency assessment of their clients.

The invention can be used for failure impact analysis to help service providers assess the resilience of their operations to understand the impact that various failures can have on their ability to deliver continuous service. With respect to change impact analysis, the invention can be used to quantify the impact of changes in the organization (infrastructure, applications, processes, or people) on the overall resiliency of the organization. For investment guidance, the model can be used to determine the most cost-effective way improve resiliency to any specific higher level. This helps identify and prioritize various weaknesses in the organization to be addressed. The invention can be used in a sales pitch by service providers seeking to win an outsourcing deal from a client. As part of proposal development, service providers can compute the resiliency score of the concerned operations of a particular client and show how outsourcing it to them would improve that score. An outsourcing decision involves selection of the vendor(s). Multiple vendors may be selected as well. The impact of various outsourcing configurations on Resiliency can be determined with the invention. With respect to using the invention for comparative analysis, an external consulting which performs multiple resiliency assessment services for various client firms can develop “best-practice” models - one for each industry. This model can be used to develop a comparative “resiliency view” of a client organization relative to the “best-practice” version for that industry. This can be used to identify weakness client's organization or to differentiate the client organization by highlighting its strengths.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

### REFERENCES

1. Trinitis et al., “How To Integrate Inter-Component Dependencies Into Combinatorial Availability Models, Reliability and Maintainability,” 2004 Annual Symposium—RAMS, 2004 Page(s):226-231.
2. Krishnmurthy et al., “On The Estimation Of Reliability Of A Software System Using Reliabilities Of Its Components,” PROCEEDINGS The International Symposium On Software Reliability Engineering 2-5 Nov. 1997 Page(s): 146-155.
3. Briggs et al., “Reliability And Availability Assessment Of Electrical And Mechanical Systems,” Industry Applications, IEEE Traisactions on Volume 34, Issue 6, November-December 1998 Page(s):1387-1396.

1-4. (canceled)

5. A method of computing a resiliency score of an entity comprising:
representing an entity as a set of components;
assigning raw resiliency scores for the said components;
determining two types of relationships between said components, wherein said two types of relationships comprise:
a dependency relationship comprising whether a first component depends on one or more additional components to function; and
a substitution relationship comprising whether two or more components share some functionality, and whether said first component can be at least partially substituted for one or more additional components; and
computing an overall score representing a resiliency of said entity from the said raw resiliency scores of said components and said relationships between said components of said entity,
wherein said assigning raw resiliency scores involves independently assessing said components for resiliency, and
wherein said relationships between said components are captured using a model having different levels of abstraction.

6-7. (canceled)
